(19) United States
(12) Patent Application Publication
(10) Pub. No.: US 2026/0148273 A1
(43) Pub. Date: May 28, 2026

(54) Systems and Methods for a Platform for Vehicle Customization and Maintenance

(71) Applicant: Brandon Alexander Cornish, Denver, CO (US)

(72) Inventor: Brandon Alexander Cornish, Denver, CO (US)

(21) Appl. No.: 19/400,977

(22) Filed: Nov. 25, 2025

Related U.S. Application Data
(60) Provisional application No. 63/724,807, filed on Nov. 25, 2024.

(51) Int. Cl. G06Q 30/0601; G06Q 10/20; G06T 7/00; G07C 5/00

(52) U.S. Cl. CPC G06Q 30/06211; G06Q 10/20; G06T 7/0004; G07C 5/006; G06Q 30/0643

(57) ABSTRACT

Systems and methods for vehicle customization and maintenance in a platform are provided. The platform allows users to explore, diagnose, and maintain vehicles using VIN-based data, interactive 3D models, and AI-driven recommendations. The platform discloses methods of integrating 360° VIN-linked part recognition, interactive garage and bay management, a multi-view system including exterior, interior, and chassis views, AI-powered predictive diagnostics, and vendor-connected marketplace synchronization. allowing real-time parts availability, price comparison, and community interaction.

### FIELD OF THE INVENTION

The present invention relates generally to vehicle information systems. Particularly, the present invention is a platform for vehicle customization that allows users to explore, diagnose, and maintain vehicles using VIN-based data, interactive 3D models, and AI-driven recommendations.

### BACKGROUND OF THE INVENTION

Finding car vehicle parts can be time-consuming and frustrating. Finding the exact vehicle part that is needed at an acceptable price point and location can add additional challenges for purchasers. Traditional automotive parts systems are fragmented and inconsistent with users relying on multiple platforms to identify, order, and install components. Existing tools lack immersive visualization or predictive artificial intelligence diagnostics. Further, vendor and supplier data are isolated, making cross-platform integration difficult. There exists a need to consolidate vendor and supplier data into a single, accessible platform to provide consumers with options for vehicle components at various prices and availabilities. Additionally, by incorporating artificial intelligence, the platform can further provide recommendations and diagnostics to users regarding vehicle parts based on the consolidated information.

An objective of the present invention is to provide a unified 360°VIN-based interface that synchronizes suppliers, users, and repair data in real-time. Users can access the present invention to access both personal garage and bay inventory and supplier, salvage yard, and aftermarket vendor inventory. The present invention eliminates the inconsistencies between multiple platforms and unifies pertinent information for the benefit of the user.

Another objective of the present invention is to provide a visualization and preview aspect for virtual customization and maintenance. Users can access the present invention and perceive various views of vehicles, such as exterior, interior, and chassis views.

The present invention further integrates artificial intelligence (AI) with the virtual platform and parts data. The present invention provides AI-based predictive diagnoses and recommendations for various vehicle maintenance and customizations.

The present invention further provides a social media platform for users including enthusiasts and professionals. Users can view and compare various garage and bay data and builds.

### SUMMARY OF THE INVENTION

Systems and methods for vehicle customization and maintenance in a platform are provided. The platform allows users to explore, diagnose, and maintain vehicles using VIN-based data, interactive 3D models, and AI-driven recommendations. The platform discloses methods of integrating 360° VIN-linked part recognition, interactive garage and bay management, a multi-view system including exterior, interior, and chassis views, AI-powered predictive diagnostics, and vendor-connected marketplace synchronization. allowing real-time parts availability, price comparison, and community interaction.

### BRIEF DESCRIPTION OF THE DRAWINGS

FIG. 1 is a graphical user interface of the present invention.

FIG. 2 is a graphical user interface of the present invention.

FIG. 3 is a graphical user interface of the present invention.

FIG. 4 is a graphical user interface of the present invention.

FIG. 5 is a graphical user interface of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention. The present disclosure includes many aspects and features. Moreover, while many aspects and features relate to, and are described in the context of the disclosed use cases, embodiments of the present disclosure are not limited to use only in this context.

Systems and methods for vehicle customization and maintenance in a platform are provided. The platform allows users to explore, diagnose, and maintain vehicles using VIN-based data, interactive 3D models, and AI-driven recommendations. The present invention provides methods of integrating 360° VIN-linked part recognition, interactive garage and bay management, a multi-view system including exterior, interior, and chassis views, AI-powered predictive diagnostics, and vendor-connected marketplace synchronization. allowing real-time parts availability, price comparison, and community interaction.

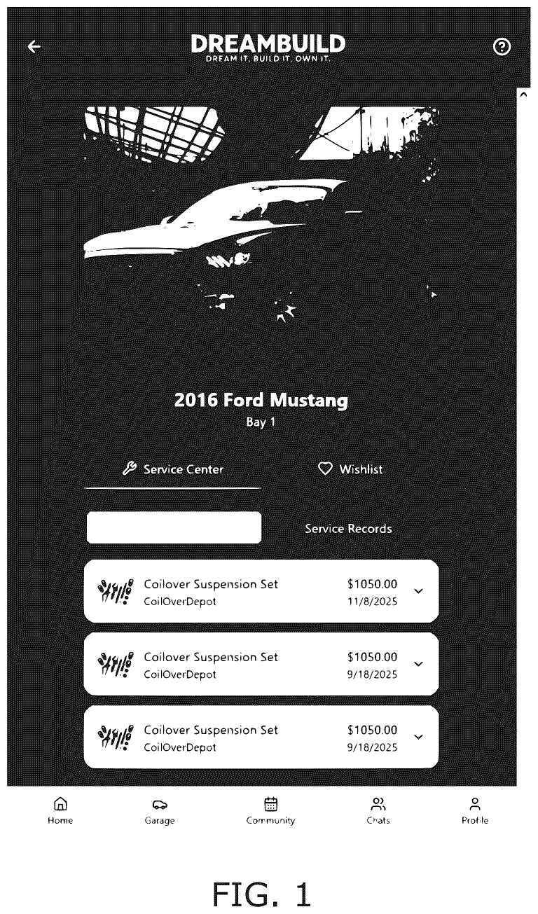

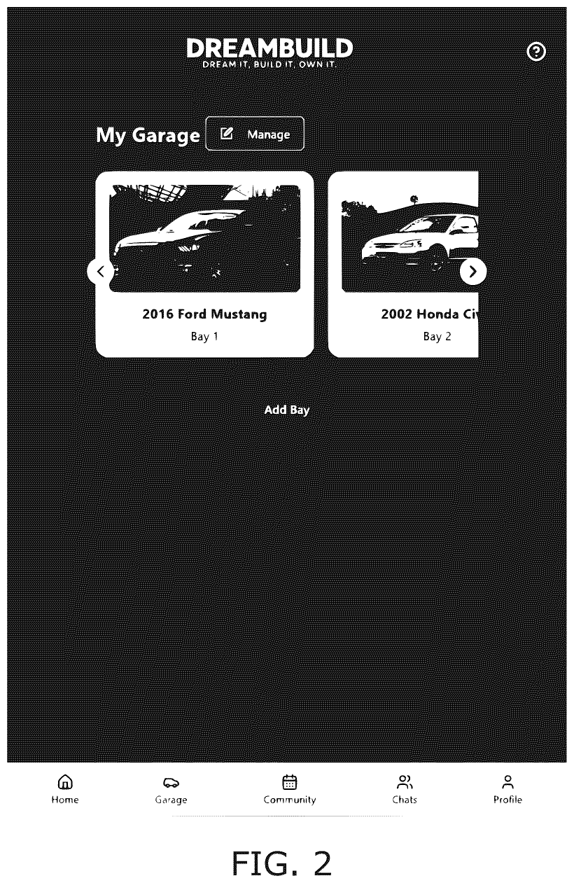

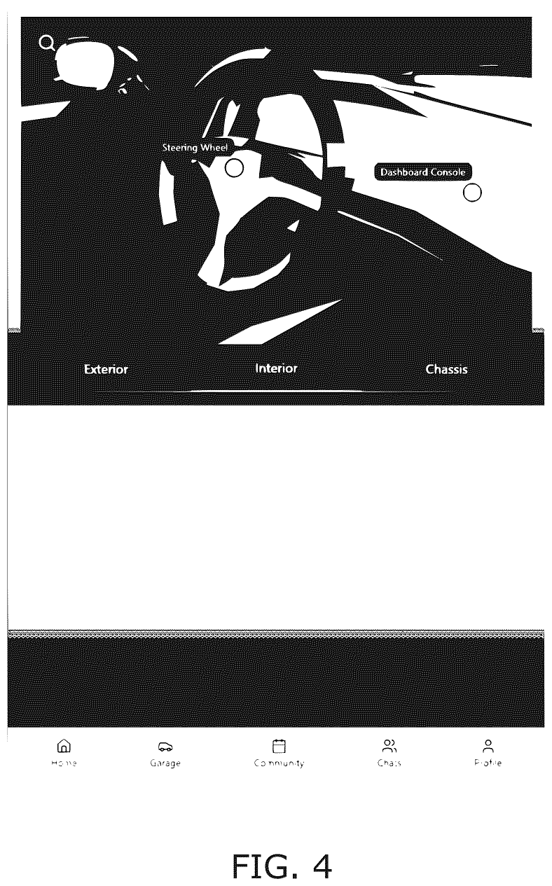

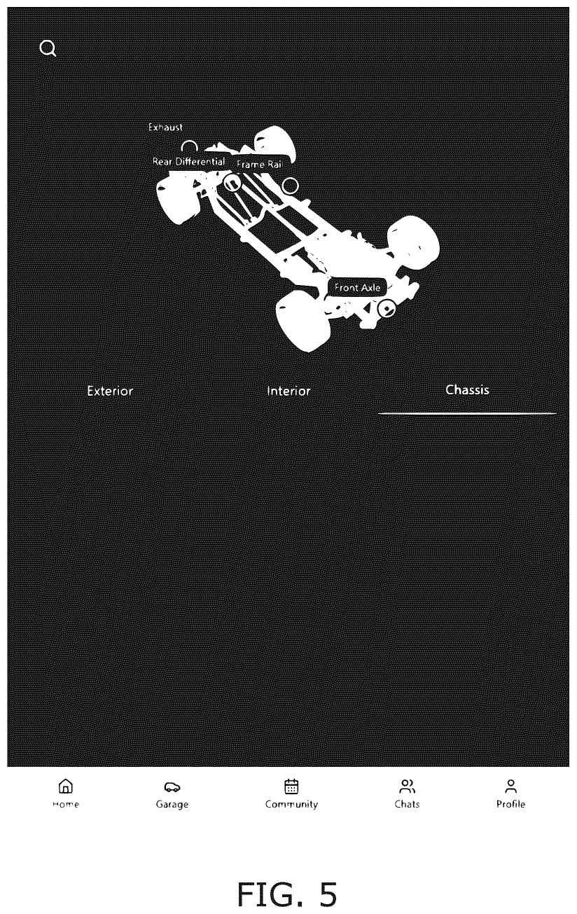

As shown in FIG. 1-5, the present invention comprises a frontend user interface, VIN recognition engine, 3D rendering environment, cloud-based data architecture, AI-based diagnostic engine, and vendor synchronization layer. In the preferred embodiment of the present invention, the present invention further comprises a community layer. In the preferred embodiment of the present invention, each layer operates independently yet communicates through standardized APIs to maintain data consistency.

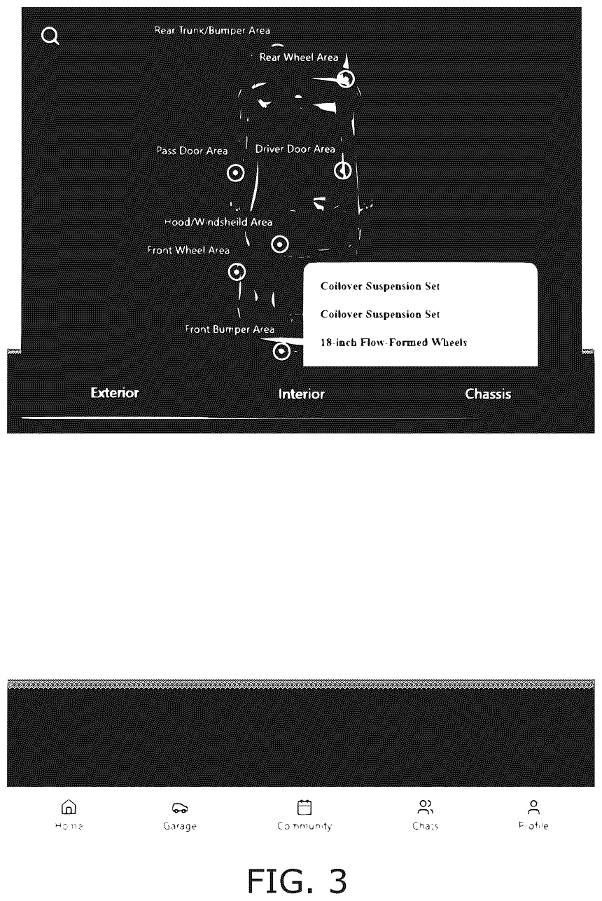

Said VIN recognition engine provides associations between VIN identification data and 3D models using cloud-based data architecture. Users can register their vehicles by VIN, then said VIN recognition engine retrieves associated 3D models segmented by component zones. In various embodiments, users can register their vehicles by year, make, and model (YMM) details, then said VIN recognition engine retrieves associated 3D models segmented by component zones. In the preferred embodiment of the present invention, the present invention comprises identification data of both VIN-linked data and YMM-linked data. In the preferred embodiment of the present invention, said component zones comprise exterior, interior, and chassis zones, as particularly shown in FIG. 3-5. The present invention displays said 3D models to the user, providing a digital preview of the registered vehicle. Said 3D rendering environment is a virtual garage management system that a user can save vehicle specifications and visual representations.

Said AI-based diagnostic engine analyzes visual data submitted by users to identify worn or damaged parts. In several embodiments, said visual data comprises images or videos. In some embodiments, said visual data further comprises audio. Said AI-based diagnostic engine generates repair suggestions to provide to the user. After analyzing said visual data, the present invention determines what vehicle parts or components can be repaired or replaced. The present invention further provides an analysis to the user regarding the vehicle parts or components that can be repaired, replaced, or otherwise adjusted.

In the preferred embodiment of the present invention, said AI-based diagnostic engine further links the user to matching inventory from partner vendors based on said repair suggestions using said vendor synchronization layer. The user is able to directly continue to purchasing parts to repair or replace any identified worn or damaged parts. Vendors can opt in to have inventory synchronized with the database of the present invention. A vendor API system connects with suppliers fetching live pricing, availability, and alternative recommendations. Said AI-based diagnostic engine learns user behavior to refine predictive maintenance and shopping experiences. Said AI-based diagnostic engine saves historical data, predictive analyses, and vehicle part specification data to a cloud environment for future use in analyses. In some embodiments, the present invention provides automatic scheduling reminders for maintenance to users.

Said community layer enables and provides a platform for social collaboration between users of the present invention. Users can share vehicle builds, tutorials, and part wishlists. Users of the present invention create and maintain an account on the platform. In the preferred embodiment of the present invention, said community layer provides customizable profiles and chats.

Although the invention has been explained in relation to its preferred embodiment, it is to be understood that many other possible modifications and variations can be made without departing from the spirit and scope of the invention.

What is claimed is:

1. A method for providing vehicle customization and maintenance, comprising:
receiving vehicle identification data from a user;
associating said vehicle identification data with vehicle part specifications;
providing a frontend user interface to a user wherein a user submits visual data of a vehicle;
receiving said visual data;
analyzing said visual data to determine diagnoses of a plurality of vehicle parts;
providing an analysis of said diagnoses to the user;
providing a visual representation of a vehicle to a user based on said VIN-linked data and vehicle part specifications;
providing a virtual management system of a plurality of vehicles based on said vehicle identification data and vehicle part specifications; and
associating said vehicle part specifications with known vendor inventory and pricing data.

2. The method for providing vehicle customization and maintenance of claim 1,
wherein said vehicle identification data further comprises:
VIN-linked data, and
YMM-linked data.

3. The method for providing vehicle customization and maintenance of claim 1, further comprising:
predicting maintenance needs of vehicle part specifications based on said diagnoses;
providing repair guidance based on said diagnoses and said maintenance needs;
wherein said diagnoses and said maintenance needs are generated by artificial intelligence.

4. The method for providing vehicle customization and maintenance of claim 1, further comprising:
providing a community platform wherein users create customizable profiles; and
associating said profiles with said virtual management system.

5. The method for providing vehicle customization and maintenance of claim 1, further comprising:
providing a visualization layer, and
mapping said vehicle part specifications to interactive 3D regions;
wherein said visualization layer displays said vehicle part specifications based on said vehicle identification data.

6. The method for providing vehicle customization and maintenance of claim 5:
wherein said visualization layer visually represents exterior, internal, and chassis representations of said vehicle part specifications based on said vehicle identification data.

7. The method for providing vehicle customization and maintenance of claim 1:
wherein said visual data further comprises audio data.

8. The method for providing vehicle customization and maintenance of claim 1, further comprising:
saving historical data, predictive analyses, and vehicle part specification data to a cloud environment.

9. The method for providing vehicle customization and maintenance of claim 1, further comprising:
notifying a user about vehicle maintenance based on vehicle identification data and vehicle part specifications.

10. A method for providing vehicle customization and maintenance, comprising:
receiving vehicle identification data from a user;
associating said vehicle identification data with vehicle part specifications;
providing a frontend user interface to a user wherein a user submits visual data of a vehicle;
receiving said visual data;
analyzing said visual data to determine diagnoses of a plurality of vehicle parts;
providing an analysis of said diagnoses to the user;
providing a visual representation of a vehicle to a user based on said vehicle identification data and vehicle part specifications;
providing a virtual management system of a plurality of vehicles based on said vehicle identification data and vehicle part specifications;
associating said vehicle part specifications with known vendor inventory and pricing data;
predicting maintenance needs of vehicle part specifications based on said diagnoses; and
providing repair guidance based on said diagnoses and said maintenance needs;
wherein said diagnoses and said maintenance needs are generated by artificial intelligence.

11. The method for providing vehicle customization and maintenance of claim 10,
wherein said vehicle identification data further comprises:
VIN-linked data, and
YMM-linked data.

12. The method for providing vehicle customization and maintenance of claim 10, further comprising:
providing a community platform wherein users create customizable profiles; and
associating said profiles with said virtual management system.

13. The method for providing vehicle customization and maintenance of claim 10, further comprising:
providing a visualization layer, and
mapping said vehicle part specifications to interactive 3D regions;
wherein said visualization layer displays said vehicle part specifications based on said vehicle identification data.

14. The method for providing vehicle customization and maintenance of claim 13:
wherein said visualization layer visually represents exterior, internal, and chassis representations of said vehicle part specifications based on said vehicle identification data.

15. The method for providing vehicle customization and maintenance of claim 10:
wherein said visual data further comprises audio data.

16. The method for providing vehicle customization and maintenance of claim 10, further comprising:
saving historical data, predictive analyses, and vehicle part specification data to a cloud environment.

17. The method for providing vehicle customization and maintenance of claim 10, further comprising:
notifying a user about vehicle maintenance based on vehicle identification data and vehicle part specifications.

18. A system for vehicle customization and maintenance, comprising:
a frontend user interface;
a VIN recognition engine;
a 3D rendering environment;
cloud-based data architecture;
AI-based diagnostic engine; and
vendor synchronization layer.

19. The system for vehicle customization and maintenance of claim 18, further comprising:
a community layer;
wherein said community layer further comprises customizable profiles.

20. The system for vehicle customization and maintenance of claim 18,
wherein said community layer further comprises a means for chat functionality.
